(19) United States
(12) Patent Application Publication
(10) Pub. No.: US 2006/0176649 A1
(43) Pub. Date: Aug. 10, 2006

(54) TASS2 (the airsafety system enhanced)

(76) Inventors: Sinatra Griffin, Park Forest, IL (US); Patricia Griffin, Park Forest, IL (US)

Correspondence Address: Pat Griffin, 9 Mantua Court, Park Forest, IL, 60466, US

(21) Appl. No.: 11/207,462

(22) Filed: Aug. 18, 2005

Related U.S. Application Data
(60) Provisional application No. 60/603,248, filed on Aug. 19, 2004.

(51) Int. Cl. H02B 1/00

(52) U.S. Cl. 361/600

(57) ABSTRACT

TASS2 provides three lines of defense for air traffic control: 1) real time surveillance; 2) emergency notification; and 3) override of navigational systems.

### CROSS-REFERENCE TO RELATED APPLICATIONS

This is a new non-provisional application relating to The Air Safety System filed as a provisional Patent Application on Aug. 19, 2004; application No. 60/603,248. The original provisional patent application was filed Mar. 25, 2002; application No. 60/367,256; confirmation number 4340; and a non-provisional patent application on Mar. 21, 2003; application Ser. No. 10/394,081—which was rejected due to new material presented.

Under ‘Detailed Description of the Invention’ paragraph 0010, the Spider Cams are also described in our BFDS non-provisional application filed on Feb. 24, 2004; application Ser. No. 10/771,568, with the benefit of 60/445,556 Feb. 06, 2003; claim 0004.

### STATEMENTS REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The AirSafety System enhanced (TASS2) pertains to the field of aviation involving the areas of operations, observation, systems and safety. It was created to facilitate designated organizations in determining the cause of aviation accidents and assist in its prevention.

1. Prior Arts

Garehime, Jr. (U.S. Pat. No. 4,112,818) created a multiple fire weapon with remote surveillance and control. As this prior art can lead to potential injury to passengers, flight crew and the aircraft—TASS2 improves this prior art by establishing control of the vehicle, with little alarm to travelers. The AirSafety System enhanced does not contain fire weapons.

Secondly, the basis of Feher (U.S. Pat. No. 4,816,828) involves cameras set within crash survivable material for surveillance of the aircraft's exterior condition—tracking damage done to the vehicle while in motion. On the contrary, TASS2 focuses on safety measures within the interior of the vehicle. The AirSafety System enhanced improves this prior art by monitoring the inner atmosphere of flights and its travelers—their words, gestures, movements, and so on.

With regards to Nelson (2003/0201365), the development of an alert system initiates an anti-hijacking system which uses the vehicle's autopilot to control flight. Accordingly, the application of this prior art is established for hijacking, or capture incidences. Improvement is made with The AirSafety System enhanced as it provides risk management and prevention regardless of the circumstance, utilizing real-time surveillance, along with override capability of navigation and flight control systems. Furthermore, contrary to Nelson, this override methodology is not triggered—or implemented—with the activation of its emergency activator.

Although TASS2 establishes an emergency activator within its system, this activator does not trigger, or implement, the system's override methodology.

The TASS2 emergency activator is intended to communicate with other team members and/or governing entities. Its purpose is to notify corresponding units of potential hazards or dangers. However, this activator does not—in any way—control the override of the vehicle's navigation.

Due to its complexity and state-of-the-art methods, the decision and initiation of override employment is not easily accessible—and not accessible anywhere on the aircraft.

The AirSafety System enhanced focuses on overall safety. It's success does not rely on whether or not the aviator, or crew, is able to initiate the system.

Moreover, the prior art of Bellman, Jr. (U.S. Pat. No. 4,831,438) allows for surveillance of the aircraft through a “tethered remote” system. TASS2 improves this prior art by allowing for possible solutions to potential imminent dangers: universal communications method; override of navigational systems; backup to data transmission methods; and accountability—or a ‘neutral observatory zone’.

Additionally, The AirSafety System enhanced allows for multiple monitoring of various vehicles simultaneously.

### BRIEF SUMMARY OF THE INVENTION

One of the most devastating occurrences is to have an aircraft in an urgent situation and there is nothing that can be done. Further, not being able to know what's going on—inside the plane—increases that sense of helplessness. The AirSafety System enhanced changes that. Knowledge of the conditions of the plane is known before utilizing black boxes.

Active communication is enhanced with the use of The AirSafety System enhanced. It allows all designated entities to have enough time to react and appropriately respond to emergencies. An imminent diagnosis is available.

When an investigation is needed, designated organizations will be able to rely on video recordings of flight conditions, in addition to the data stored in the CSMU; thereby reducing hours spent on caseloads.

By allowing governing entities to become actively involved with the aviator, crew and passengers—the overall safety of the flight dramatically increases. Furthermore, designated entities have the opportunity to obtain more control of the aircraft, specifically when the aviator needs help.

### BRIEF DESCRIPTION OF THE SEVERAL VIEWS OF THE DRAWING

FIG. 1. TASS2 Control Station A

FIG. 2. TASS2 Control Station B

FIG. 3. Vehicle Floor Plan

FIG. 4. TASS2 Spider Cameras

FIG. 5. Camera Mount track

FIG. 6. Multi-Screened Monitors

FIG. 7. Emergency Activator

FIG. 8. TASS2 Network

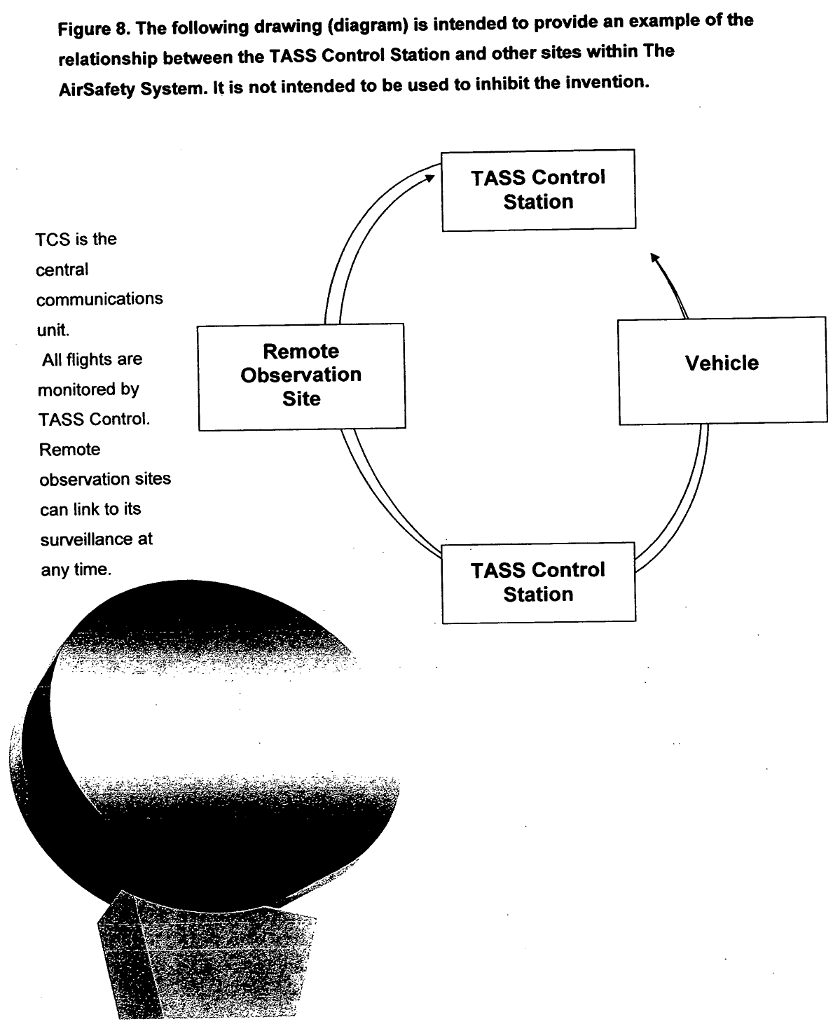

### DETAILED DESCRIPTION OF THE INVENTION

Locations

Remote Site

The AirSafety System enhanced may be used along side the Air Traffic Control System Command Center (ATCSCC) or other entity. As it oversees all air traffic control, TASS allows the user to monitor flight activity within the vehicle in real time.

TASS2 Control Station (TCS)

TCS serves as the communications link between the vehicle and the remote site. It is the brained mainframe that stores all data transmitted, including all undergoing activity within The AirSafety System; thereby serving as a neutral observation zone. All actions taken by the user—including the TCS itself—and all data transmitted and received are recorded and stored within the mainframe. Upon needed investigation, users may refer to the stored data for research and examination.

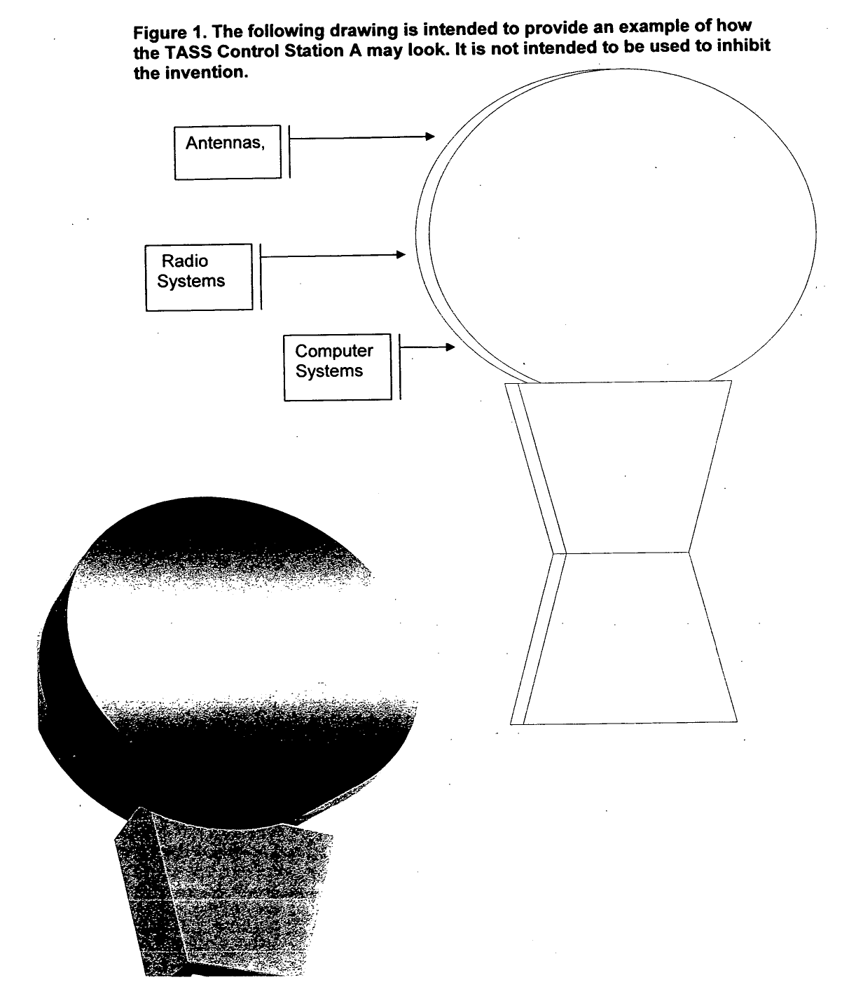

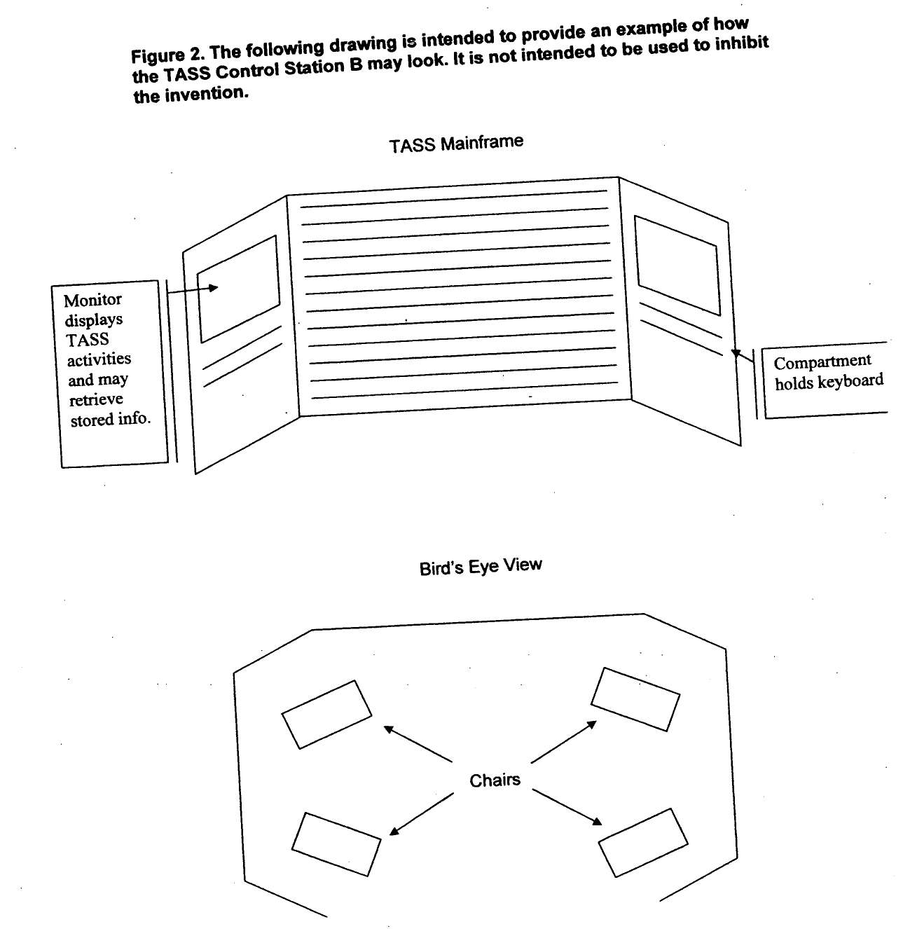

The TASS2 Control Station may be a freestanding building (as depicted in FIG. 1), or it may be housed within the ATCSCC or other system (FIG. 2) having its antennas mounted on top of a roof, or similar thereof. Each TCS is designed to handle the flight activity within the divisions of U.S. airspace, or other airspace systems around the world.

Vehicle

TASS2 is installed within the vehicle's operating system. Surveillance is achieved via cameras which are initiated as the vehicle's power is generated. TCS stores data received by the cameras, allowing the user to monitor flight activity at any time.

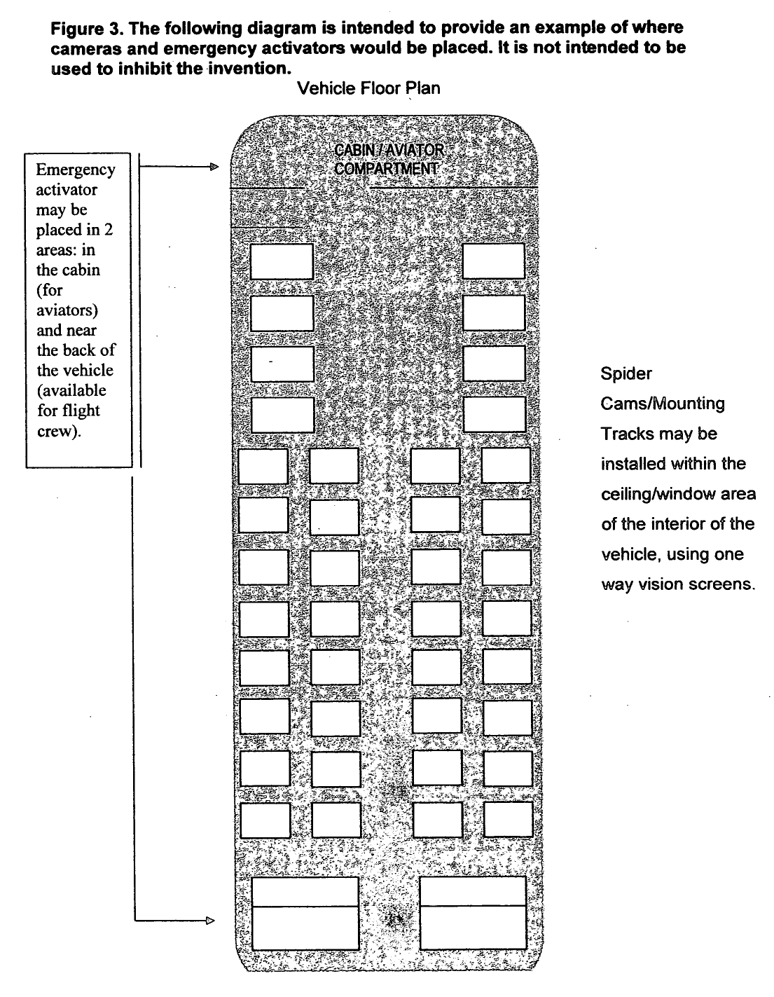

Cameras may be installed along the ceiling or windows area of the vehicle using a one-way vision screen, (FIG. 3), in addition, emergency activators are available to the aviators as well as the flight crew.

Key Components

Spider Cameras

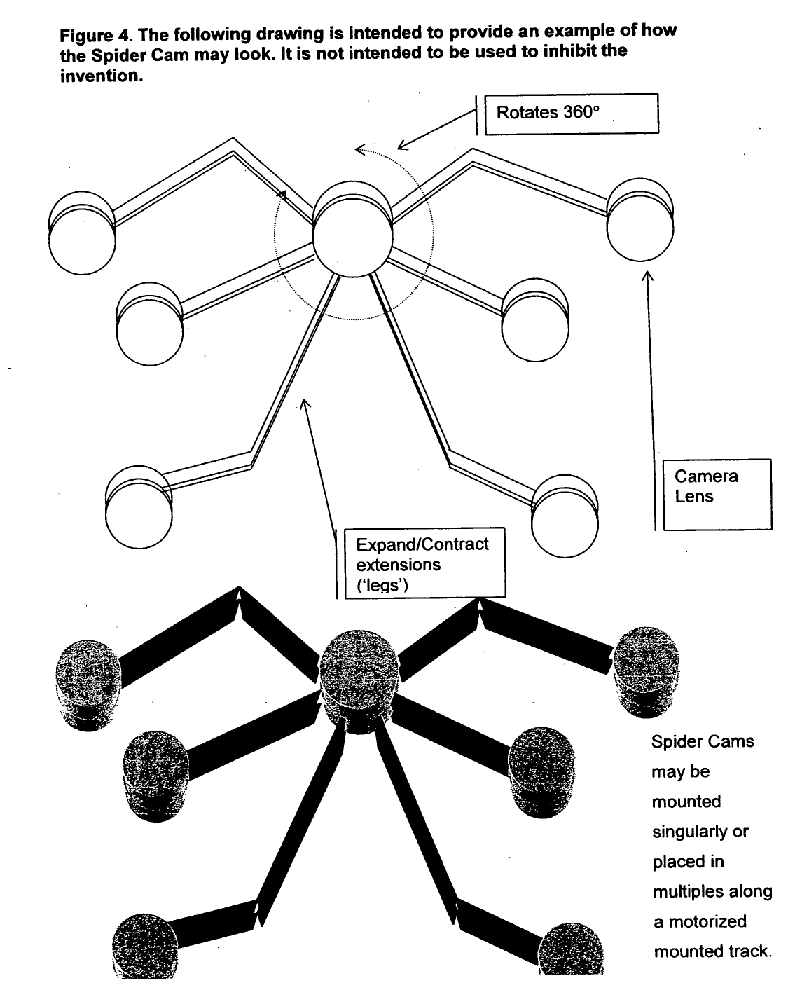

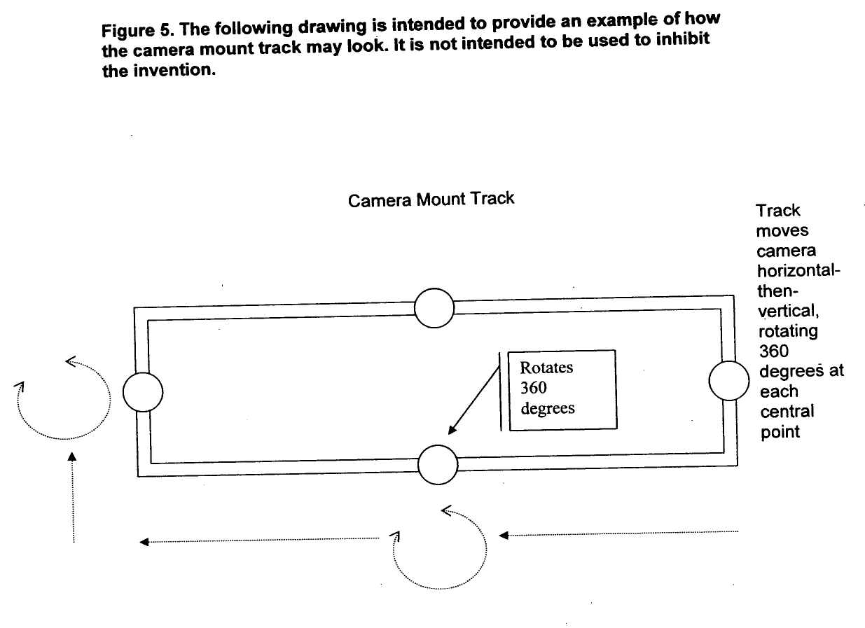

As FIG. 4 indicates, this six legged machinery is equipped with cameras and motorized legs that extend/expand or curtail/contract. These Spider Cams may stand alone using a rotational mount, or be mounted on a rectangular track (FIG. 5), gradually moving the camera horizontally—then—vertically, with a 360 degree rotation at each central position. Further, identification of the vehicle (flight) can be made by downloading the cameras serial numbers with the corresponding serial numbers of the vehicle into the TASS mainframe. This identification can then be matched to the flight progress strip, or similar thereof.

Multi-Screened Monitors

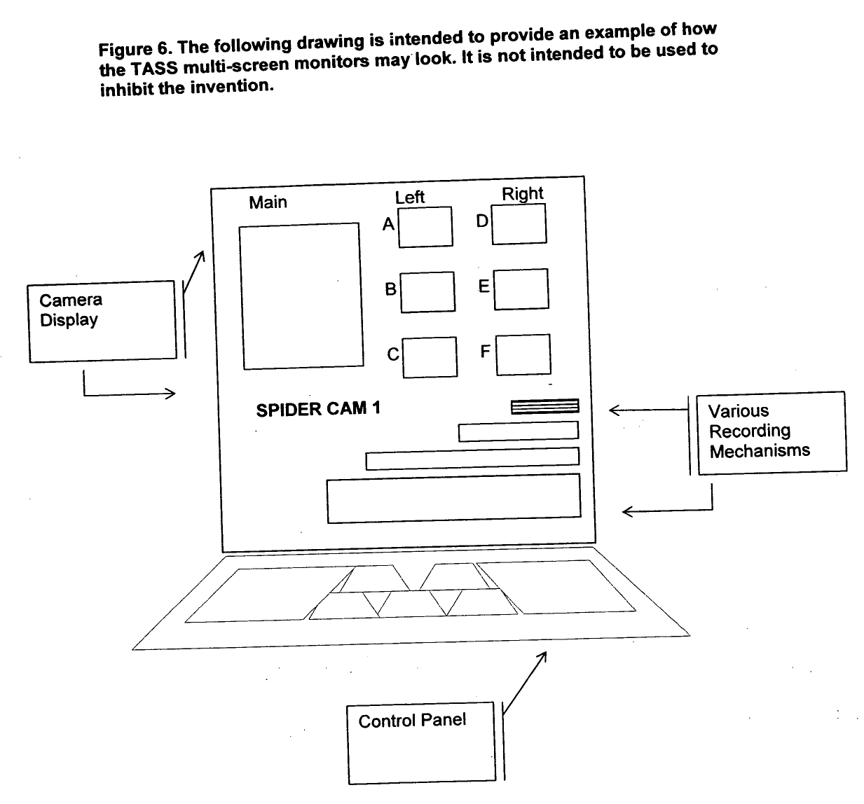

Multi-screened monitors (FIG. 6) are used to view data received by the Spider Cams. Although the TCS records all data transmitted and received, the user may individually store data onto portable hardware, such as: discs, tapes, and so on.

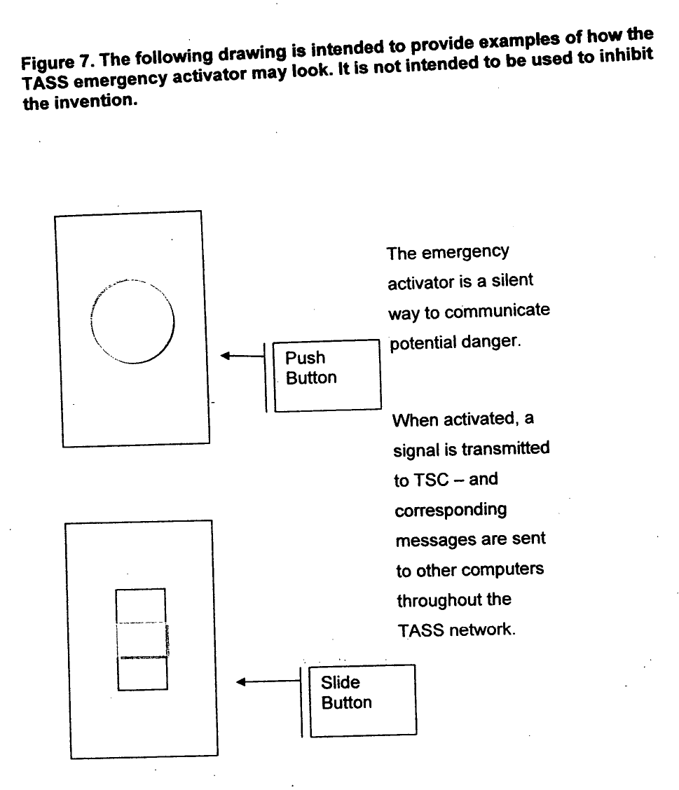

Emergency Activator (FIG. 7)

There may be at least 2 emergency activators installed within the vehicle: one for aviator in the cabin area (for example); and one near the back of the vehicle for flight crew (refer to FIG. 3). Although the TASS2 Control Station monitors and records all data transmitted by the Spider Cams, initiation of the emergency activator may trigger the user to monitor that specific flight. As the emergency activator is initiated, communication is sent to the TCS—with corresponding alert messages, and interoperable communication, among all TASS2 computers within the network.

Operations

Satellite Communication

Generally, a satellite consists of the bus, source of power, onboard computer, radio system and antenna. The satellite used within The AirSafety System enhanced will fly at a low altitude in a polar orbit, or similar thereof. The polar orbit remains fixed in space as the Earth rotates inside the orbit, achieving excellent coverage of the planet. As initiation of the Spider Cams is achieved through the vehicle's power generation, real time data from the cameras are transmitted to the non-geosynchronous satellite, and then received by the TASS2 Control Station (via satellite transmission).

Likewise, all data transmission, reception and instruction are achieved via various radio systems using continuous sine waves. Each radio signal uses a different sine wave frequency. Each sine wave uses an amplitude or frequency modulation, or combination thereof, to encode the information on it.

The transmitter takes a message (voice, pictures, data, and so on), encodes it onto a sine wave and transmits it with radio waves. The receiver receives the radio waves and decodes the message from the sine wave it receives. Both the transmitter and receiver use antennas to radiate and capture each radio signal. Further, the transmitters and receivers are used simultaneously and are able to understand hundreds of different frequencies, and can switch between frequencies.

Satellite Internet Communication

Communication between the TASS2 Control Station and the computers within the TASS2 network (users, ATCSCC, and so on) uses satellite internet, instead of telephone lines or cable systems. A satellite dish is utilized for two way (upload and download) data communication, along with two modems (uplink and downlink) and coaxial cables between the dish and modem.

Override of Navigational and Flight Systems

At the discretion of the user, override of the distraught vehicle's navigation is available. An average vehicle uses approximately 12 gyroscopes. According to ‘How Stuff Works.com,’ at the start of a trip, the axis (gyroscopic compass) is pointed north using a magnetic compass as a reference. A motor inside the gyrocompass keeps the gyroscope spinning, keeping the gyrocompass pointing north. Periodically, the gyrocompass is checked against the magnetic compass to correct any error it might pick up. If two gyroscopes are mounted with their axles at right angles to one another on a platform, and the platform is placed inside a set of gimbals, the platform will remain completely rigid as the gimbals rotate as they please. This is the basis of inertial navigation systems (INS). In an INS, sensors on the gimbals' axles detect when the platform rotates. The INS uses those signals to understand the vehicle's rotations relative to the platform. Add to the platform a set of three sensitive accelerometers, you can tell exactly where the vehicle is heading and how its motion is changing in all three directions. With this information, an airplane's autopilot can keep on course, and a rocket's guidance system can insert the rocket into a desired orbit. Accordingly, through gyroscopic-gimbals manipulation via encrypted instruction transmitted with radio signals, TASS can program or redirect the course of a vehicle. Further, the non-geosynchronous satellite locates landing sites in relation to the vehicle's coordinates and transmits that data to the TASS Control Station, where coordinating maps are generated. Once the best site is deduced (either manually by the user, or automatically—at the discretion of the user), instructions are received by the satellite and transmitted to the vehicle's operating system.

Once the vehicle receives override instruction from The AirSafety System, all navigational systems are inoperable from within the cabin. In other words, the process can not be changed, manipulated, or disrupted from within the vehicle.

1. What is claimed as the invention is a system or method of integrating the following components within aviation:
camera(s);
orbital computerized communication;
computer network;
multi-screened monitor(s);
emergency activator(s);
data storage;
data warehousing;
override of navigational systems.

1[a] Relating to claim 0001, the invention includes a system or method of integrating the following components within aviation:
real time surveillance;
emergency notifier.

2. What is claimed as the invention is the creation of a horizontal-then-vertical mount track, with rotating axles.

3. What is claimed as the invention is the creation of a brained mainframe, consisting of the following components, or combination thereof:
gyroscopic manipulation
gimbals manipulation;
map generation;
data storage and warehousing;
multiple antennas.

3[a] Relating to claim 0003, our invention includes a system or method of a low altitude, non-geosynchronous computerized object put into orbit around the earth, used within aviation, consisting of the following elements or combination thereof:
real time data;
gyroscopic instruction;
land(ing) locator.

4. What is claimed as the invention is a system or method, integrating the following elements within a singular communication usage:
orbital computerized object;
multiple modems;
multiple cables;
multiple antennas;
computer network.
